(19) United States
(12) Patent Application Publication
(10) Pub. No.: US 2002/0189501 A1
(43) Pub. Date: Dec. 19, 2002

(54) Hydraulically setting compositions comprising alkylamines

(75) Inventors: Knut Oppenlander, Ludwigshafen (DE); Joachim Pakusch, Speyer (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Aktiengesellshaft, Ludwigshafen (DE)

(21) Appl. No.: 10/082,093

(22) Filed: Feb. 26, 2002

(30) Foreign Application Priority Data
Mar. 1, 2001 (DE) 101 09 995.9

(51) Int. Cl. C04B 14/00; C04B 24/00

(52) U.S. Cl. 106/727

(57) ABSTRACT

Compounds of the formula I

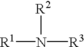

wherein the radicals R¹, R² and R³ independently of one another are a hydrogen atom or an organic group having from 1 to 40 carbon atoms, with the proviso that at least one of R¹ to R³ is an organic group having from 10 to 40 carbon atoms,

or salts of the above compounds

are used as additives for mineral binders.

The invention relates to the use of compounds of the formula I

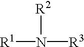

wherein the radicals R¹, R² and R³ independently of one another are a hydrogen atom or an organic group having from 1 to 40 carbon atoms, with the proviso that at least one of R¹ to R³ is an organic group having from 10 to 40 carbon atoms,

or of salts of the above compounds

as additives for mineral binders.

The invention further relates to hydraulically setting compositions comprising compounds of the formula I or salts of said compounds.

By adding additives to hydraulically setting compositions, it is possible to set or alter the performance properties. For instance, it is known that adding water repellents reduces the water absorption of hydraulically setting compositions. In DE-A-27 00 890, lime, for example, is made water-repellent by adding stearates. EP-A-500 637 discloses the addition of metal salts of fatty acids.

DE-A-19 914 367 relates to the addition of amidobetaines, ethercarboxylic acids or alkylbetaines, in particular to plaster.

The existing water repellents are often still inadequate in their action, or are needed in large amounts for an adequate action.

It is an object of the present invention to provide compounds having an improved water repellency action or having an improved activity for a smaller amount.

We have found that this object is achieved by the above-defined use of the compounds of the formula I. We have also found hydraulically setting compositions comprising compounds of the formula I.

The compounds of the formula I are primary, secondary or tertiary amines or their salts.

The radicals R¹ to R³ independently of one another are a hydrogen atom or an organic group having from 1 to 40 carbon atoms with the proviso that at least one of the radicals R¹ to R³ is an organic group having from 10 to 40 carbon atoms.

In general, the organic groups are preferably hydrocarbon groups; that is, these groups consist only of carbon and hydrogen. They may be saturated or unsaturated hydrocarbon groups, preference being given to saturated hydrocarbon groups. Consequently, they are in particular alkyl groups.

With preference, one, two or all three radicals R¹-R³ are a C₁₀-C₃₀ alkyl group, with particular preference a C₁₂ to C₂₆ alkyl group, with very particular preference a C₁₄ to C₂₂ alkyl group, e.g., a stearyl group (C₁₈H₃₇).

Where only one or two of the radicals R¹-R³ is or are such an alkyl group, the (two) other radical(s) is (are) preferably a hydrogen atom or, if appropriate, a short-chain alkyl group, e.g., a C₁-C₈ alkyl group. With particular preference, the remaining radical or radicals is or are a hydrogen atom.

As suitable compounds of the formula I, mention may be made, by way of example, of

stearylamine, distearylamine or tristearylamine.

Besides the compounds of the formula I, their salts may also be used.

Particularly suitable are the carboxylic salts in which the carboxylic acid is the anion (R⁴COO^{⊖}) and the compound of the formula I is the cation (HN^{⊕}R¹R²R³).

In particular, the salt in question is the salt of an aliphatic carboxylic acid. The carboxylic acid consists preferably of a total of from 10 to 40, more preferably from 14 to 30 , carbon atoms. Accordingly, R⁴ is an organic radical, in particular a C₉-C₃₉ alkyl group, with particular preference a C₁₃-C₂₉ alkyl group.

Mention may be made, by way of example, of the salts of fatty acids, e.g., stearic acid.

The compounds of the formula I or their salts are used as additives to mineral binders.

Particularly suitable mineral binders include hydraulically setting binders, i.e., binders which harden following the addition of water.

As hydraulic binders, mention may be made of plaster, lime, clay, and cement. The preferred binder is cement. Suitable cements include blast furnace slag cement, oil shale cement, Portland cement, water-repellency-treated Portland cement, quick-setting cement, high-alumina cement, and high-expansion cement. Portland cement is very particularly preferred.

The mineral binders are used in the construction industry in building material formulations or adhesive formulations.

The building material formulations are, for example, formulations for plasters or screeds, pointing mortar or concrete.

The adhesive formulations are, for example, tile adhesives.

Besides the mineral binder and the compound of the formula I, or salt thereof, the building material formulations or adhesive formulations of the invention may include further additives.

Of particular suitability are mineral aggregates such as quartz sand and gravel, fillers such as calcium carbonate, and pigments such as titanium dioxide and iron oxide.

The formulations may further comprise polymer powders. In the case of the building material formulations, polymer powders are used in particular to enhance the mechanical properties, e.g., for increased elasticity of the hardened building materials.

In the case of the adhesive formulations, the polymer powders are often used to increase the tack.

Further possible auxiliaries in the building material formulations or adhesive formulations are, for example, defoamers, thickeners, plasticizers, biocides, etc.

The building material formulations or adhesive formulations are initially dry formulations. The constituents are mixed as solids, generally in the form of powders.

The compounds of the formula I or their salts are preferably mixed into this dry formulation. It is also possible to mix the compounds first of all with other constituents, e.g., with the polymer powder, and then to add this mixture to the dry formulation.

The building material formulation or adhesive formulation comprises preferably from 0.1 to 10 parts by weight, with particular preference from 0.2 to 2 parts by weight, of the compounds of the formula I or their salts per 100 parts by weight of dry formulation, i.e., based on the sum of all constituents formulation except for water.

The fraction of the mineral binder, preferably cement, may 15 distinctly differ depending, for example, on whether the formulation in question is a building material formulation or an adhesive formulation; in general, the amount is from 5 to 90 parts by weight, in particular from 10 to 50 parts by weight, per 100 parts by weight of dry formulation.

### EXAMPLES

I Water Repellent

### Inventive: Examples B1-B4

### Comparative: Examples C1-C4

| Example | Chemical name | Formula |
|---|---|---|
| B1 | stearylamine | H₃₇C₁₈NH₂ |
| B2 | salt | H₃₇C₁₈NH₂^{⊕} |
| | stearylamine/ | H₃₅C₁₇COO^{⊖} |
| | stearic acid | |
| B3 | salt | (H₃₇C₁₈)₂NH₂^{⊕} |
| | distearylamine/ | H₃₅C₁₇COO^{⊖} |
| | stearic acid 60 μm | |
| | particle size | |
| B4 | as B3 | (H₃₇C₁₈)₂NH₂^{⊕} |
| | 10 μm particle size | H₃₅C₁₇COO^{⊖} |
| C1 | silicone resin | |
| | (product BS 49 from | |
| | Wacker Chemie) | |
| C2 | stearic acid | H₃₅C₁₇COOH |
| C3 | amide stearylamine/ stearic acid | 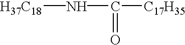 |
| C4 | amide distearylamine/ stearic acid | 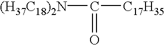 |

Details relating to the preparation of the water repellents

Salt Stearylamine/Stearic Acid (B2)

| Amount | mol | Substance |
|---|---|---|
| 85.2 g | 0.3 | Melt stearic acid and |
| 80.7 g | 0.3 | octadecylamine together at about 80° C., leave to |
| | | stir for 1 h, leave to cool in an aluminum dish, |
| | | break out from dish, and grind. |
| | | 156.85 g (white powder) |

Salt Distearylamine/Stearic Acid (B3, B4)

| Amount | mol | |
|---|---|---|
| 312.6 g | 0.6 | distearylamine |
| 170.49 g | 0.6 | stearic acid |

Stir at 90° C. for one hour.

Amide Stearylamine/Stearic Acid (C3)

| Amount | mol | |
|---|---|---|
| 85.2 g | 0.3 | stearic acid |
| 80.7 g | 0.3 | stearylamine |

Test Procedure:

Stir at 170° C. until water is no longer distilled off. Precipitate, grind.

Amide Distearylamine/Stearic Acid (C4)

| Amount | mol | |
|---|---|---|
| 56.8 g | 0.2 | stearic acid |
| 104.2 g | 0.2 | distearylamine |

Test Procedure:

Stir at 200° C. until water is no longer distilled off.

II Performance Testing

The water repellents were mixed with cement mortar (standard mortar in accordance with EN 196-1).

The weight fraction of the water repellents was 0.5 part by weight per 100 parts by weight of dry matter. The mortar was mixed with water.

The water absorption was tested in accordance with EN 196-1.

The cement mortar is introduced into the two-part specimen mold according to EN 196-1.

After 28 days' storage time (standard conditions, 21° C., 1 bar), the water absorption was measured.

The initial weight of the specimens is measured and a line is made at a height of 15 mm on all 4 sides of the specimen. The specimen is suspended in a glass beaker so that there is a 25 space of 1 cm between the base of the glass beaker and the bottom of the specimen.

At the start of the test, the glass beakers are filled with tap water up to the marking on the specimens, and are aligned horizontally. The samples then are in freely suspended immersion to a depth of 15 mm in the water. At the respective points in time during the test, the specimens are removed from the water, their surface is dried off with a towel, and they are again weighed. After the final weighing (24 hours), the specimen is split open lengthwise using a hammer and chisel and the depth of penetration of the water is measured to the nearest millimeter.

Water absorption by the Bärlocher method, weight increase in %

| | | | | | | | Height of rise |
|---|---|---|---|---|---|---|---|
| | 0.5 h | 1 h | 3 h | 5 h | 7 h | 24 h | in 24 h [mm] |
| 0 value* | 1.87 | 2.34 | 3.30 | 3.78 | 4.03 | 4.71 | 62 |
| B1 | 0.09 | 0.11 | 0.13 | 0.15 | 0.16 | 0.21 | 0 |
| B2 | 0.19 | 0.23 | 0.29 | 0.32 | 0.33 | 0.44 | 1 |
| B3 | 0.07 | 0.08 | 0.08 | 0.13 | 0.13 | 0.21 | 0 |
| B4 | 0.05 | 0.07 | 0.09 | 0.09 | 0.09 | | 0 |
| C1 | 0.59 | 0.86 | 1.23 | 1.33 | 1.37 | 1.48 | 6 |
| C2 | 0.34 | 0.37 | 0.48 | 0.53 | 0.58 | 0.80 | 2 |
| C3 | 1.52 | 1.91 | 2.58 | 2.93 | 3.11 | 3.55 | 45 |
| C4 | 0.81 | 0.98 | 1.24 | 1.35 | 1.44 | 1.60 | 14 |

*without water repellent

1. The use of compounds of the formula I 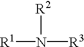
wherein the radicals R¹, R² and R³ independently of one another are a hydrogen atom or an organic group having from 1 to 40 carbon atoms, with the proviso that at least one of R¹ to R³ is an organic group having from 10 to 40 carbon atoms,
or of salts of the above compounds
as additives for mineral binders.

2. The use as claimed in claim 1, wherein the organic groups are saturated hydrocarbon groups.

3. The use as claimed in claim 1, wherein one, two or three of the radicals R¹ to R³ are a C₁₀ to C₃₀ alkyl group.

4. The use as claimed in claim 1, wherein the additive is a carboxylic salt of the compound of the formula I.

5. The use as claimed in claim 4, wherein the salt is the salt of an aliphatic carboxylic acid having from 10 to 40 carbon atoms.

6. A building material formulation or adhesive formulation comprising mineral binders and a compound of the formula I or salt thereof.

7. A building material formulation or adhesive formulation as claimed in claim 6, comprising from 0.1 to 10 parts by weight of the compounds I or their salts per 100 parts by weight of dry matter, i.e., based on the sum of all constituents of the mixture except for water.

8. A building material formulation or adhesive formulation as claimed in claim 6, wherein the mineral binder is a hydraulically setting binder.
